(19) United States
(12) Patent Application Publication
(10) Pub. No.: US 2026/0023970 A1
(43) Pub. Date: Jan. 22, 2026

(54) HARDWARE AND SOFTWARE CO-DESIGN METHOD WITH MIXED-PRECISION ALGORITHM AND COMPUTING-IN-MEMORY-BASED ACCELERATOR AND SYSTEM THEREOF, AND NON-TRANSITORY COMPUTER READABLE RECORDING MEDIUM

(71) Applicant: NATIONAL TSING HUA UNIVERSITY, HSINCHU (TW)

(72) Inventors: Kea-Tiong TANG, Taipei City (TW); Yen-Wen CHEN, Tainan City (TW); Jui-Hsuan WANG, Hsinchu City (TW); Yu-Hsiang CHENG, Hsinchu (TW); Chih-Cheng LU, Hsinchu (TW); Meng-Fan CHANG, Hsinchu (TW)

(21) Appl. No.: 18/890,804

(22) Filed: Sep. 20, 2024

(30) Foreign Application Priority Data
Jul. 19, 2024 (TW) 113127232

(51) Int. Cl. G06N 3/082; G06N 3/063

(52) U.S. Cl. CPC G06N 3/082; G06N 3/063

(57) ABSTRACT

A hardware and software co-design system with a mixed-precision algorithm and a computing-in-memory (CIM)-based accelerator includes a memory, a processor and the CIM-based accelerator. The processor performs operations including obtaining a plurality of sets of initial weight parameters of a pre-trained model from the memory; performing a pruning procedure on the sets of initial weight parameters to generate a plurality of sets of pruned weights; and performing a filter-wise mixed-precision quantization training on a plurality of non-zero weights of the sets of pruned weights to generate a plurality of filter weights with different bit widths, and pairing the filter weights to generate a plurality of paired filter weight groups, and mixing the paired filter weight groups to generate a plurality of mixed-precision weights. The CIM-based accelerator performs a CIM operation on the mixed-precision weights and a plurality of sets of input parameters to generate a plurality of CIM outputs.

### RELATED APPLICATIONS

This application claims priority to Taiwan Application Serial Number 113127232, filed Jul. 19, 2024, which is herein incorporated by reference.

### BACKGROUND

### Technical Field

The present disclosure relates to a hardware and software co-design method and a system thereof, and a non-transitory computer readable recording medium. More particularly, the present disclosure relates to a hardware and software co-design method with a mixed-precision algorithm and a computing-in-memory-based accelerator and a system thereof, and a non-transitory computer readable recording medium.

### Description of Related Art

Convolutional Neural Networks (CNNs) are crucial in deep learning applications, but demand resources. The parallel computing capability of Computing-In-Memory (CIM) achieves high energy efficiency in artificial intelligence accelerators. When implementing CNN in CIM, quantization and pruning are significant to reduce computational complexity and enhance hardware efficiency.

Conventional CIM-based accelerators only support fixed-precision calculations. Therefore, when operating on mixed-precision networks, a significant amount of CIM memory is wasted on storing meaningless zero values, and computational resources are squandered on meaningless computations, rendering the advantages of mixed-precision networks ineffective. Consequently, a hardware and software co-design method with a mixed-precision algorithm and a CIM-based accelerator and a system thereof, and a non-transitory computer readable recording medium which are capable of enabling full-scale computations for mixed-precision networks and improving CIM utilization and computational speed are commercially desirable.

### SUMMARY

According to one aspect of the present disclosure, a hardware and software co-design system with a mixed-precision algorithm and a computing-in-memory (CIM)-based accelerator includes a memory, a processor and the CIM-based accelerator. The memory stores a plurality of sets of initial weight parameters of a pre-trained model and a plurality of sets of input parameters. The processor is electrically connected to the memory and configured to perform operations including performing an initial weight obtaining operation, a pruning quantization joint training operation and a mixed-precision quantization operation. The initial weight obtaining operation includes obtaining the sets of initial weight parameters of the pre-trained model from the memory. The pruning quantization joint training operation includes performing a pruning procedure on the sets of initial weight parameters to generate a plurality of sets of pruned weights. The mixed-precision quantization operation includes performing a filter-wise mixed-precision quantization training on a plurality of non-zero weights of the sets of pruned weights to generate a plurality of filter weights with different bit widths, and pairing the filter weights to generate a plurality of paired filter weight groups, and mixing the paired filter weight groups to generate a plurality of mixed-precision weights. The CIM-based accelerator is electrically connected to the memory and the processor, and receives the mixed-precision weights and the sets of input parameters. The CIM-based accelerator performs a CIM operation on the mixed-precision weights and the sets of input parameters to generate a plurality of CIM outputs.

According to another aspect of the present disclosure, a hardware and software co-design method with a mixed-precision algorithm and a computing-in-memory (CIM)-based accelerator including configuring a processor to obtain a plurality of sets of initial weight parameters of a pre-trained model from a memory; configuring the processor to perform a pruning quantization joint training step, wherein the pruning quantization joint training step includes performing a pruning procedure on the sets of initial weight parameters to generate a plurality of sets of pruned weights; configuring the processor to perform a mixed-precision quantization step, wherein the mixed-precision quantization step includes performing a filter-wise mixed-precision quantization training on a plurality of non-zero weights of the sets of pruned weights to generate a plurality of filter weights with different bit widths, and pairing the filter weights to generate a plurality of paired filter weight groups, and mixing the paired filter weight groups to generate a plurality of mixed-precision weights; and configuring the CIM-based accelerator to perform a CIM operation on the mixed-precision weights and a plurality of sets of input parameters to generate a plurality of CIM outputs.

According to further another aspect of the present disclosure, a non-transitory computer readable recording medium storing instructions which when executed by a processor and a computing-in-memory (CIM)-based accelerator causes the processor and the CIM-based accelerator to perform a hardware and software co-design method with a mixed-precision algorithm and the CIM-based accelerator. The hardware and software co-design method with the mixed-precision algorithm and the CIM-based accelerator includes configuring the processor to obtain a plurality of sets of initial weight parameters of a pre-trained model from a memory; configuring the processor to perform a pruning procedure on the sets of initial weight parameters to generate a plurality of sets of pruned weights; configuring the processor to perform a filter-wise mixed-precision quantization training on a plurality of non-zero weights of the sets of pruned weights to generate a plurality of filter weights with different bit widths, and pair the filter weights to generate a plurality of paired filter weight groups, and mix the paired filter weight groups to generate a plurality of mixed-precision weights; and configuring the CIM-based accelerator to perform a CIM operation on the mixed-precision weights and a plurality of sets of input parameters to generate a plurality of CIM outputs.

### BRIEF DESCRIPTION OF THE DRAWINGS

The present disclosure can be more fully understood by reading the following detailed description of the embodiment, with reference made to the accompanying drawings as follows:

FIG. 1A shows a schematic view of a hardware and software co-design system with a mixed-precision and algorithm a computing-in-memory (CIM)-based accelerator according to a first embodiment of the present disclosure.

FIG. 1B shows a flow chart of a hardware and software co-design method with a mixed-precision algorithm and a CIM-based accelerator according to a second embodiment of the present disclosure.

FIG. 2 shows a schematic view of an overall CIM macro architecture with a mixed-precision weight mapping scheme of the present disclosure.

FIG. 3 shows a schematic view of structured pruning in a CIM mode of the present disclosure.

FIG. 4 shows a schematic view of adaptive paired-to-paired mixed precision in the CIM mode of the present disclosure.

FIG. 5 shows a schematic view of pruned-weight distribution and paired-mixed-weight distribution of the present disclosure.

FIG. 6 shows a schematic view of a filter-wise mixed-precision quantization training searching process of the present disclosure.

FIG. 7A shows a schematic view of a weight distribution of filter 7 in layer 2 of Resnet18 of the present disclosure.

FIG. 7B shows a schematic view of a weight distribution of filter 15 in layer 2 of Resnet18 of the present disclosure.

FIG. 8A shows a schematic view of a weight distribution of filter 53 in layer 2 of Resnet18 of the present disclosure.

FIG. 8B shows a schematic view of a weight distribution of filter 61 in layer 2 of Resnet18 of the present disclosure.

FIG. 9A shows a schematic view of a hardware and software co-design system with a mixed-precision algorithm and a CIM-based accelerator according to a third embodiment of the present disclosure.

FIG. 9B shows a flow chart of a hardware and software co-design method with a mixed-precision algorithm and a CIM-based accelerator according to a fourth embodiment of the present disclosure.

FIG. 10 shows a schematic view of a CIM-based accelerator of the hardware and software co-design system of FIG. 1A.

FIG. 11 shows a schematic view of a multi-bit weight block (M-BWB) of a mixed-precision mapping method of the present disclosure in which two groups of weights are mapped to a same partition.

FIG. 12 shows a schematic view of a reconfigurable shift-and-adder of the CIM-based accelerator of FIG. 10.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

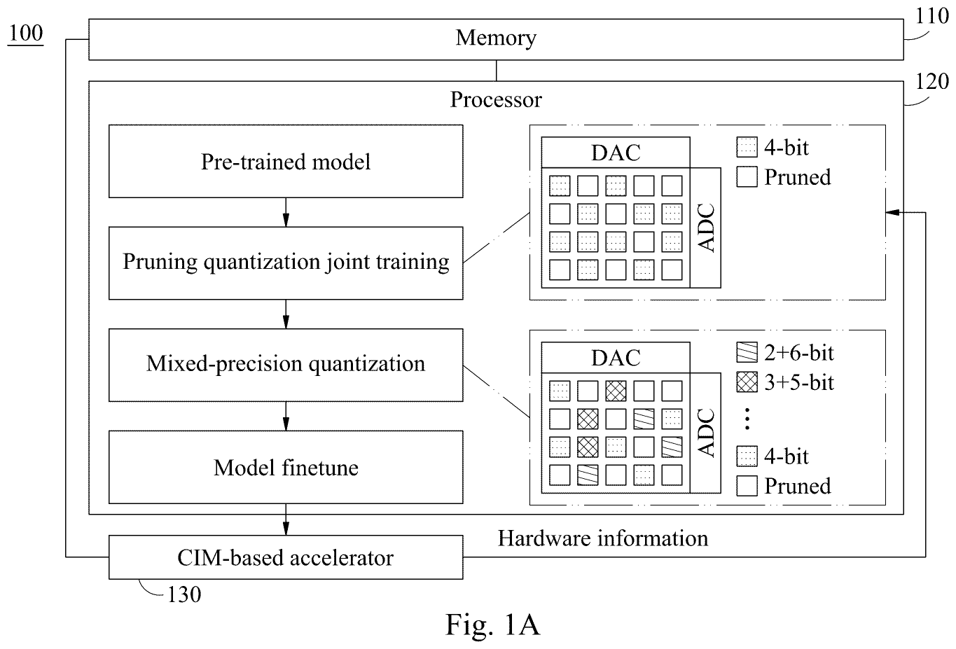

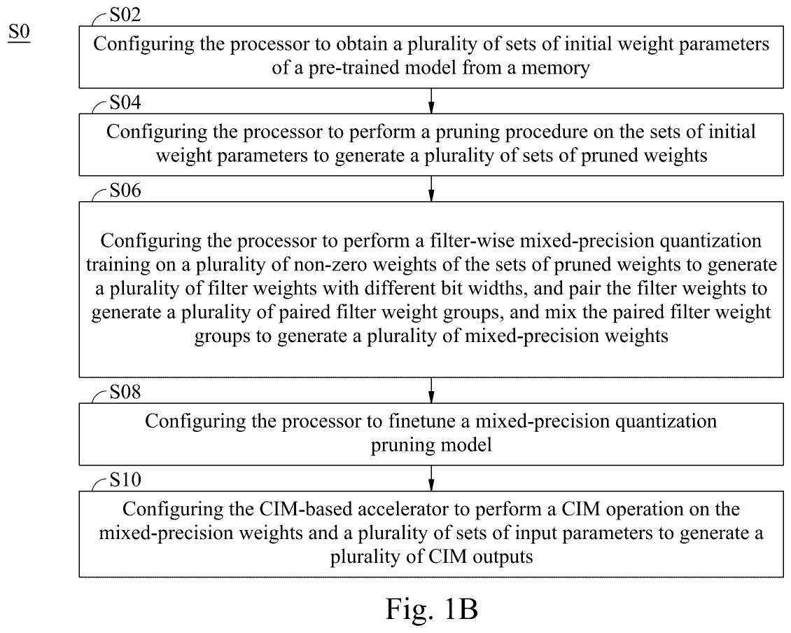

Reference is made to FIGS. 1A and 1B. FIG. 1A shows a schematic view of a hardware and software co-design system 100 with a mixed-precision algorithm and a computing-in-memory (CIM)-based accelerator according to a first embodiment of the present disclosure. FIG. 1B shows a flow chart of a hardware and software co-design method SO with a mixed-precision algorithm and a CIM-based accelerator according to a second embodiment of the present disclosure. The hardware and software co-design system 100 with the mixed-precision algorithm and the CIM-based accelerator is configured to perform the hardware and software co-design method SO with the mixed-precision algorithm and the CIM-based accelerator, and includes a memory 110, a processor 120 and the CIM-based accelerator 130. The memory 110 stores a plurality of sets of initial weight parameters of a pre-trained model and a plurality of sets of input parameters. The processor 120 is electrically connected to the memory 110 and configured to perform operations including performing an initial weight obtaining operation, a pruning quantization joint training operation, a mixed-precision quantization operation and a model finetuning operation. The initial weight obtaining operation includes obtaining the sets of initial weight parameters of the pre-trained model from the memory 110. The pruning quantization joint training operation includes performing a pruning procedure on the sets of initial weight parameters to generate a plurality of sets of pruned weights. The mixed-precision quantization operation includes performing a filter-wise mixed-precision quantization training on a plurality of non-zero weights of the sets of pruned weights to generate a plurality of filter weights with different bit widths, and pairing the filter weights to generate a plurality of paired filter weight groups, and mixing the paired filter weight groups to generate a plurality of mixed-precision weights. The model finetuning operation includes finetuning a mixed-precision quantization pruning model. The mixed-precision quantization pruning model is formed by performing the pruning quantization joint training operation and the mixed-precision quantization operation.

The CIM-based accelerator 130 is electrically connected to the memory 110 and the processor 120, and receives the mixed-precision weights and the sets of input parameters. The CIM-based accelerator 130 performs a CIM operation on the mixed-precision weights and the sets of input parameters to generate a plurality of CIM outputs. Therefore, the hardware and software co-design system 100 with the mixed-precision algorithm and the CIM-based accelerator of the present disclosure utilizes the pruning quantization joint training operation and the mixed-precision quantization operation to enable full-scale computations for mixed-precision networks and improve CIM utilization and computational speed, thereby solving the problem of conventional fixed-precision calculations for mixed-precision networks with low utilization and reduced computational efficiency.

The hardware and software co-design system 100 with the mixed-precision algorithm and the CIM-based accelerator and the hardware and software co-design method SO thereof of the present disclosure utilize a CIM adaptive mixed-precision joint pruning quantization (CAMPQ) algorithm which includes four features. The first feature is a CIM friendly mapping architecture (CFMA). The second feature is a two-stage joint training framework. The third feature is a filter-wise mixed-precision quantization (FWMQ) method. The fourth feature is a CIM-adaptive paired-to-paired bit-width discretization (P2P) method.

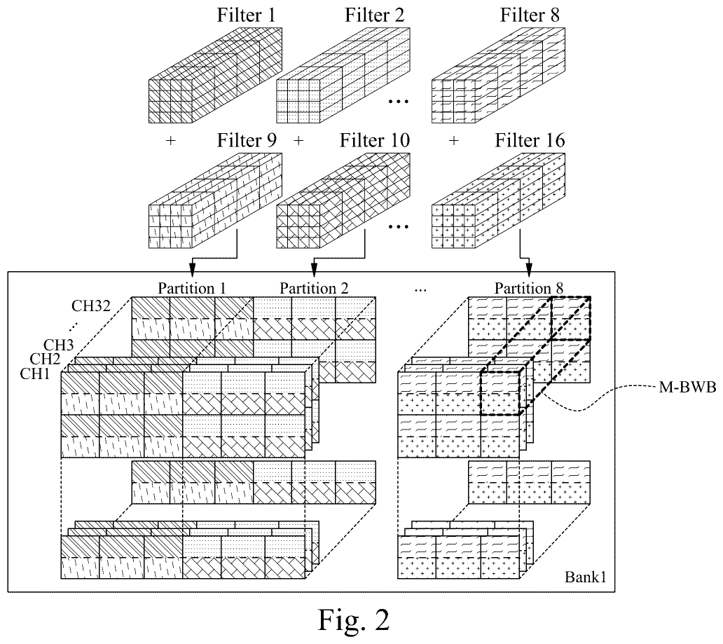

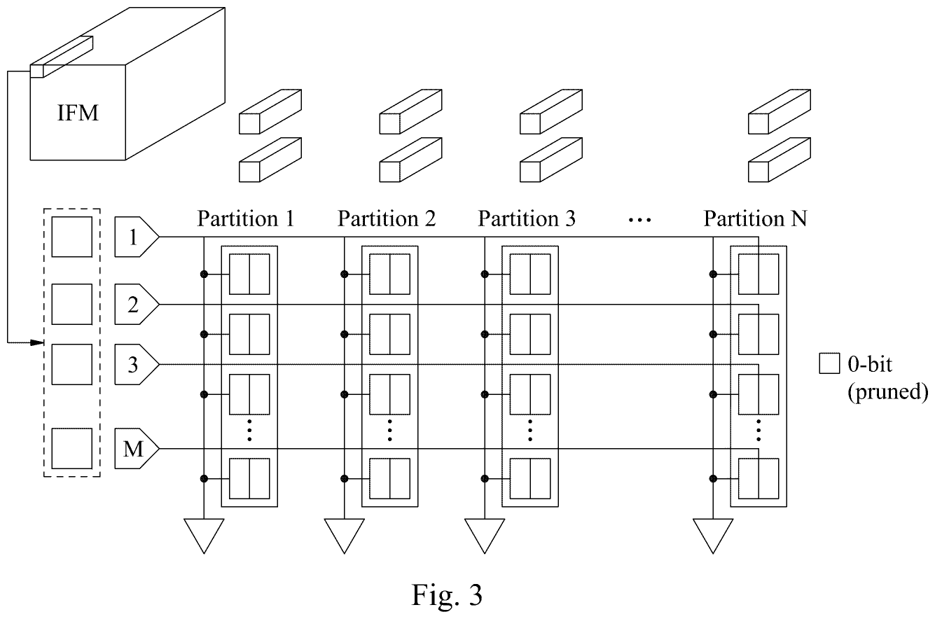

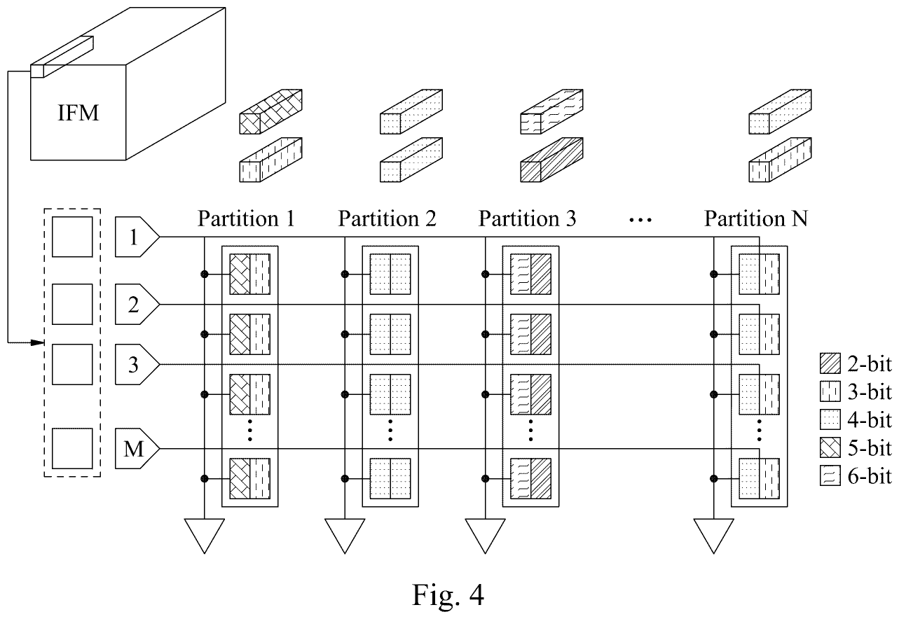

Reference is made to FIGS. 1A, 1B, 2, 3 and 4. FIG. 2 shows a schematic view of an overall CIM macro architecture with a mixed-precision weight mapping scheme of the present disclosure. FIG. 3 shows a schematic view of structured pruning in a CIM mode of the present disclosure. FIG. 4 shows a schematic view of adaptive paired-to-paired mixed precision in the CIM mode of the present disclosure. FIGS. 2, 3 and 4 are corresponding to the CIM friendly mapping architecture (CFMA). In the overall CIM macro architecture, each bank (such as bank Bank1) includes 8 partitions. Each partition includes 64 multi-bit weight blocks (M-BWB). The goal of the CAMPQ algorithm of the present disclosure is to allow the multi-bit weight block (M-BWB) to calculate a plurality of paired filter weight groups at one time instead of calculating one filter weight at one time. Filters stored in different banks are merged into the same bank, thus allowing two filters to share the same multi-bit weight block (M-BWB). Each bank (such as bank Bank1) calculates 16 filters at the same time. For example, the multi-bit weight block (M-BWB) of the first partition (Partition 1) calculates the first filter (Filter 1) and the ninth filter (Filter 9) at the same time. The multi-bit weight block (M-BWB) of the second partition (Partition 2) calculates the second filter (Filter 2) and the tenth filter (Filter 10) at the same time. The multi-bit weight block (M-BWB) of the eighth partition (Partition 8) calculates the eighth filter (Filter 8) and the sixteenth filter (Filter 16) at the same time, and so on. In FIGS. 3 and 4, the CIM-based accelerator 130 determines whether to perform the CIM operation with input feature map (IFM) and a plurality of mixed-precision weights (corresponding to the paired filter weight groups) according to the condition of the mixed-precision weight mapping scheme. In one embodiment, the values N and M can be 8 and 64, respectively, but the present disclosure is not limited thereto.

There are two conditions in the mixed-precision weight mapping scheme. The first condition is that an entire set of weights is zero distribution (0-bit), as shown in FIG. 3. The model may have a condition where the entire weight submatrix is 0 through structured pruning training in the first stage of CAMPQ (i.e., the pruning quantization joint training operation). When computing-in-memory (CIM) encounters the condition of all Os, the input will be skipped without computation, thereby further reducing the number of access in the memory and the energy consumption for transporting data. In addition, the second condition is that the weight distribution is mixed-precision distribution, as shown in FIG. 4. Each weight has a different number of bits through mixed-precision quantization training in the second stage of CAMPQ (i.e., the mixed-precision quantization operation). For example, the first partition (Partition 1) can store a 5-bit weight and a 3-bit weight at the same time. The second partition (Partition 2) can store two 4-bit weights at the same time. The third partition (Partition 3) can store a 6-bit weight and a 2-bit weight at the same time. The Nth partition (Partition N) can store a 4-bit weight and a 3-bit weight at the same time. In other words, in the CIM friendly mapping architecture (CFMA), one of the mixed-precision weights corresponds to one of the paired filter weight groups, and the one of the paired filter weight groups includes two of the filter weights. Each of the paired filter weight groups includes a first filter weight and a second filter weight. The first filter weight and the second filter weight are mixed into a same partition to generate the one of the mixed-precision weights. The first filter weight and the second filter weight have a first bit width (e.g., 5-bit) and a second bit width (e.g., 3-bit), respectively. The one of the mixed-precision weights has a third bit width (e.g., 8-bit), and the third bit width is equal to the first bit width plus the second bit width. Therefore, the present disclosure allows the multi-bit weight block (M-BWB) to calculate multiple filter weights simultaneously, thereby not only improving CIM utilization, but also further increasing the output quantity of CIM.

The hardware and software co-design method SO with the mixed-precision algorithm and the CIM-based accelerator includes performing a plurality of steps S02, S04, S06, S08, S10. The step S02 corresponds to the initial weight obtaining operation. The step S04 corresponds to the pruning quantization joint training operation. The step S06 corresponds to the mixed-precision quantization operation. The step S08 corresponds to the model finetuning operation. In detail, the step S02 includes configuring the processor 120 to obtain a plurality of sets of initial weight parameters of a pre-trained model from a memory 110. The step S04 includes configuring the processor 120 to perform a pruning quantization joint training step, and the pruning quantization joint training step includes performing a pruning procedure on the sets of initial weight parameters to generate a plurality of sets of pruned weights. The step S06 includes configuring the processor 120 to perform a mixed-precision quantization step. The mixed-precision quantization step includes performing a filter-wise mixed-precision quantization training on a plurality of non-zero weights of the sets of pruned weights to generate a plurality of filter weights with different bit widths, and pairing the filter weights to generate a plurality of paired filter weight groups, and mixing the paired filter weight groups to generate a plurality of mixed-precision weights. The step S08 includes configuring the processor 120 to finetune a mixed-precision quantization pruning model, and the mixed-precision quantization pruning model is formed by performing the pruning quantization joint training step (i.e., the step S04) and the mixed-precision quantization step (i.e., the step S06). The step S10 includes configuring the CIM-based accelerator 130 to perform a CIM operation on the mixed-precision weights and a plurality of sets of input parameters to generate a plurality of CIM outputs. Therefore, the hardware and software co-design method SO with the mixed-precision algorithm and the CIM-based accelerator of the present disclosure utilizes the CIM adaptive mixed-precision joint pruning quantization (CAMPQ) algorithm to enable full-scale computations for mixed-precision networks and improve CIM utilization and computational speed, thereby solving the problem of conventional fixed-precision calculations for mixed-precision networks with low utilization and reduced computational efficiency.

In one embodiment, the pre-trained model can be a convolutional neural network (CNN), and the pruning procedure can be corresponding to a group lasso regularization, which utilizes hardware information to allow the hardware to access data more conveniently. The model finetuning operation can be corresponding to batch normalization (BN) fusion finetune, but the present disclosure is not limited thereto.

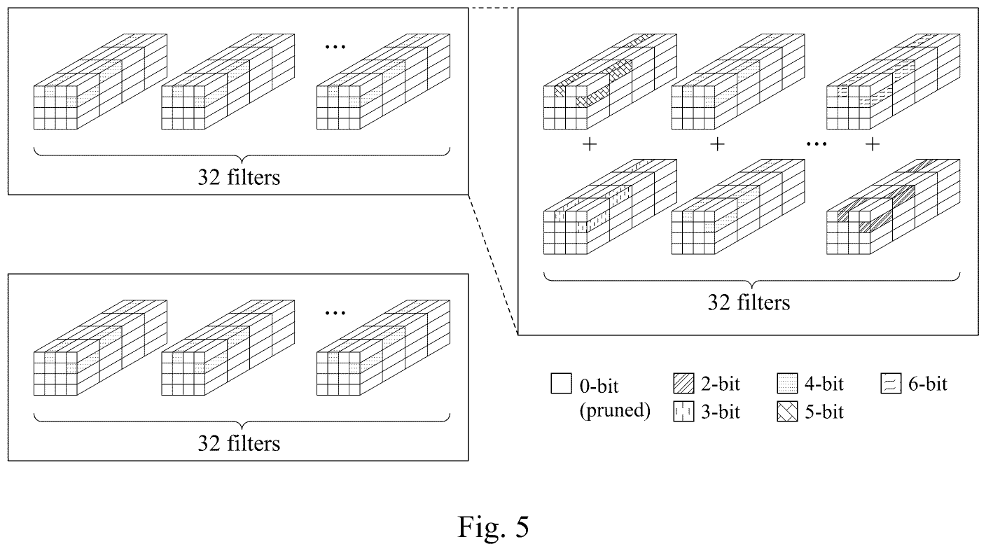

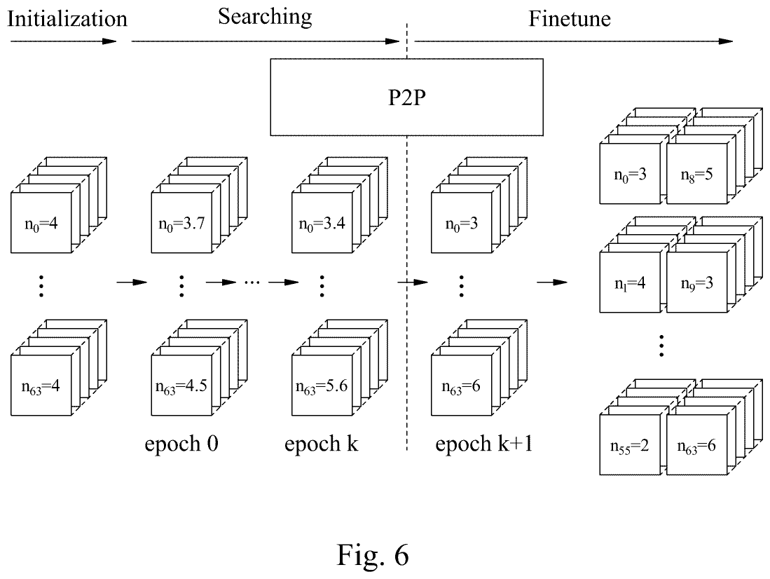

Reference is made to FIGS. 1A, 1B, 2, 3, 4, 5 and 6. FIG. 5 shows a schematic view of pruned-weight distribution and paired-mixed-weight distribution of the present disclosure. FIG. 6 shows a schematic view of a filter-wise mixed-precision quantization training searching process of the present disclosure. FIG. 5 corresponds to the two-stage joint training framework. The two-stage joint training framework includes the first stage and the second stage.

The structured pruning training in the first stage (i.e., the pruning quantization joint training operation) may allow computation of the computing-in-memory (CIM) to be skipped when the weights are all 0 according to the calculation characteristics of the CIM, thereby reducing the number of access in the memory and increasing the efficiency of computation. By adding the group least absolute shrinkage and selection operator regularization (group lasso regularization) to the objective function, the network can prune the model under the hardware limitation of the CIM, such as the white parts in each partition in FIG. 5 which have been pruned to 0.

The mixed-precision quantization training in the second stage (i.e., the mixed-precision quantization operation) is to perform a training process with mixed-precision quantization on the network which has been pruned in the first stage. The training process includes an initialization operation, a searching operation and a finetuning operation, as shown in FIG. 6. The mixed-precision quantization training in the second stage may generate different combinations of bit widths for each non-zero filter, and perform pairing according to the hardware limitation of the CIM. The initialization operation includes initializing each filter to a 4-bit value. The searching operation includes utilizing stochastic gradient descent (SGD) to find the appropriate number of bits for different filters during the training period (the training period includes a plurality of training epochs, such as epoch 0, epoch k, epoch k+1). The finetuning operation includes quantizing the filters into different bit widths, thereby filling the bit-cells in the M-BWB when computing low-bit weights.

In the filter-wise mixed-precision quantization (FWMQ) method, the filter-wise mixed-precision quantization training is calculated as follows:

$${x}_{q} = Q ( x , [ {n}_{i} , Δ ] ) = clip ( ⌈ \frac{x}{Δ} ⌋ , - {n}_{i} , {n}_{i} - 1 ) \times Δ ; \qquad ( 1 )$$

where Q (x, [nᵢ, Δ]) represents that an input signal x is quantized into a b-bit output signal x_{q} by parameters [nᵢ, Δ]; n; represents a step number matrix which is a continuous value; Δ represents a step size of quantization function; [x/Δ] represents rounding of x/Δ; and clip

$$( ⌈ \frac{x}{Δ} ⌋ , - {n}_{i} , {n}_{i} - 1 )$$

represents that when input [x/Δ] is smaller than −nᵢ, −nᵢ is the output [x/Δ] is greater than nᵢ−1, nᵢ−1 or equal to nᵢ−1, [x/Δ] is output. The above formula (1) represents a weight quantization function. In one embodiment, the bit width b is restricted to one of 0, 2, 3, 4, 5, 6 and 8. In order to quantize each weight into a different value of step numbers and increase the accuracy of the mixed-precision network, the present disclosure utilizes a filter-wise quantization method when quantizing the weights.

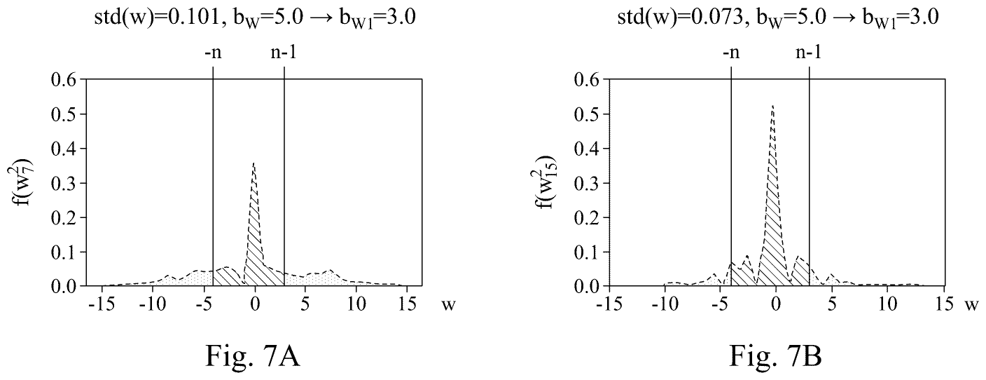

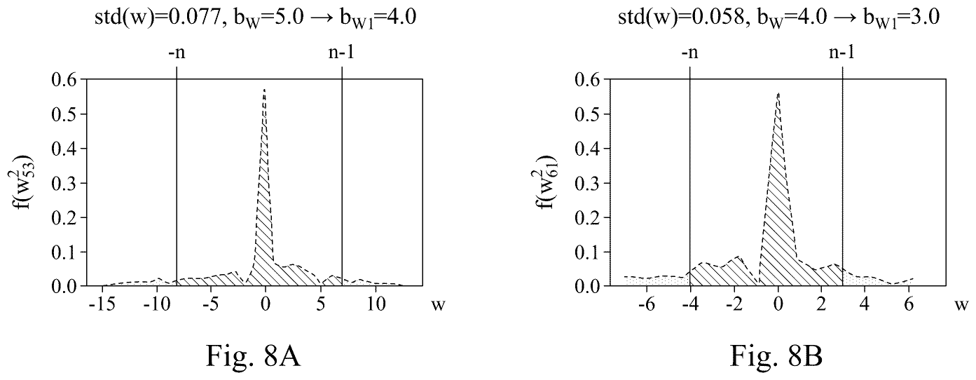

Reference is made to FIGS. 1A, 1B, 2, 3, 4, 5, 6, 7A, 7B, 8A and 8B. FIG. 7A shows a schematic view of a weight distribution of filter 7 in layer 2 of Resnet18 of the present disclosure. FIG. 7B shows a schematic view of a weight distribution of filter 15 in layer 2 of Resnet18 of the present disclosure. FIG. 8A shows a schematic view of a weight distribution of filter 53 in layer 2 of Resnet18 of the present disclosure. FIG. 8B shows a schematic view of a weight distribution of filter 61 in layer 2 of Resnet18 of the present disclosure. FIGS. 7A, 7B, 8A and 8B are corresponding to the CIM-adaptive paired-to-paired bit-width discretization (P2P) method. After searching for the step number n for each filter, the continuous step numbers n are discretized to discrete bit widths b by using the following formula (2). The bit width b is fixed for the subsequent fine-tuning in the subsequent training epochs. The formula (2) is shown as follows:

$$b = round ( {log}_{2} ( n + 1 ) ) + 1. \qquad ( 2 )$$

However, the bit width of the paired filter weight groups might exceed the upper limit of precision of the multi-bit weight block (M-BWB). In this situation, the bit width may be adjusted. In order to reduce the resulting quantization error caused by changing the bit width, the present disclosure considers the standard deviation (SD) of each filter weight as a benchmark to adjust the precision.

In order to analyze the standard deviation of weights, the weight distribution can be conceptualized as a probability density function (PDF), and the quantization error can be approximated as follows:

$$error \approx {\int }_{- ∞}^{- Δ n} f ( w ) dw {\int }_{Δ ( n - 1 )}^{∞} f ( w ) dw ; \qquad ( 3 )$$

where f(w) represents the PDF of the weight. In FIGS. 7A, 7B, 8A and 8B,

$$f ( {w}_{k}^{l} )$$

on the y-axis represents the PDF of the k-th weight in the I-th layer, and I is equal to 2, and k is equal to 7, 15, 53 or 61; w on the x-axis represents the weight; std (w) represents the standard deviation of the weight; b_{w} represents an original bit width of the weight; b_{w1} represents a target bit width of the weight; the vertical lines corresponding to −n and n−1 represent the range of the target bit width; and a part smaller than-n or another part larger than n−1 represents the external quantization error.

The bit width of the paired filter weight groups might exceed the upper limit in two cases. The first case is that both the bit widths of the multi-bit weight block (M-BWB) are greater than 4. For example, the standard deviation of filter 7 in FIG. 7A is 0.101, and the original bit width is 5-bit. The standard deviation of filter 15 in FIG. 7B is 0.073, and the original bit width is 5-bit. If the bit width of filter 7 is modified, filter 7 will become 3-bit values, which complements the 5-bit of filter 15. The external quantization error for the weight with a large standard deviation (FIG. 7A) is considerably greater than that for the weight with a small standard deviation (FIG. 7B). Therefore, the weights with smaller standard deviations may be adjusted first if both the bit widths are greater than 4 (i.e., filter 15 is adjusted first).

The second case is that one of the bit widths of the multi-bit weight block (M-BWB) is less than 4. For example, the standard deviation of filter 53 in FIG. 8A is 0.077, and the original bit width is 5-bit. The standard deviation of filter 61 in FIG. 8B is 0.058, and the original bit width is 4-bit. When the quantization error is approximated using the formula (3), the definite integral increases rapidly because the weight distribution of filter 61 is more centralized, which leads to higher quantization errors. Therefore, when one of the bit widths is less than 4, reducing the step number for the weight with the higher standard deviation (longer bit width) can minimize the quantization error (i.e., filter 53 is adjusted first).

From the above, it can be seen that the CIM-adaptive paired-to-paired bit-width discretization (P2P) method is implemented in the mixed-precision quantization step. In detail, the mixed-precision quantization operation further includes in response to determining that the paired filter weight groups are generated, the processor 120 checks whether a sum of the first bit width and the second bit width is greater than a predetermined mixed-precision bit width (e.g., 8-bit) to generate a first checking result. In response to determining that the first checking result is yes, the processor 120 checks whether the first bit width and the second bit width are both greater than a predetermined intermediate bit width (e.g., 4-bit) to generate a second checking result, and adjusts one of the first bit width and the second bit width according to the second checking result. On the contrary, in response to determining that the first checking result is no, the processor 120 mixes the first filter weight and the second filter weight into the same partition to generate the one of the mixed-precision weights.

In addition, the mixed-precision quantization operation further includes in response to determining that the second checking result is yes, the processor 120 calculates a first standard deviation of the first filter weight and a second standard deviation of the second filter weight, and compares the first standard deviation and the second standard deviation to output a smaller one of the first standard deviation and the second standard deviation. If the smaller one is the first standard deviation, the processor 120 adjusts the first bit width. If the smaller one is the second standard deviation, the processor 120 adjusts the second bit width, so that the sum of the first bit width and the second bit width is equal to the predetermined mixed-precision bit width. On the contrary, in response to determining that the second checking result is no, the processor 120 calculates the first standard deviation of the first filter weight and the second standard deviation of the second filter weight, and compares the first standard deviation and the second standard deviation to output a larger one of the first standard deviation and the second standard deviation. If the larger one is the first standard deviation, the processor 120 adjusts the first bit width. If the larger one is the second standard deviation, the processor 120 adjusts the second bit width, so that the sum of the first bit width and the second bit width is equal to the predetermined mixed-precision bit width.

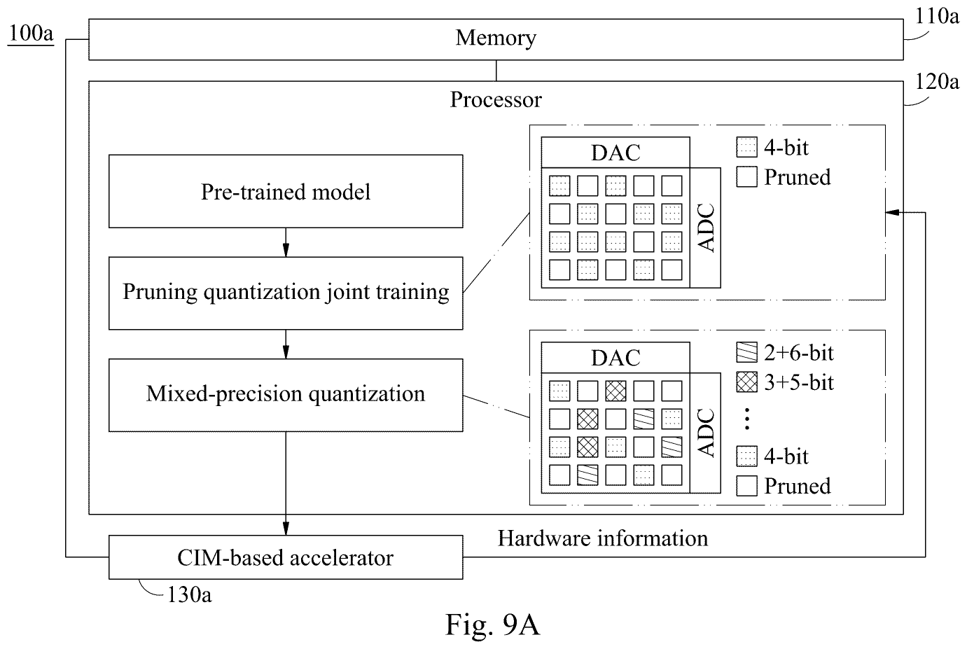

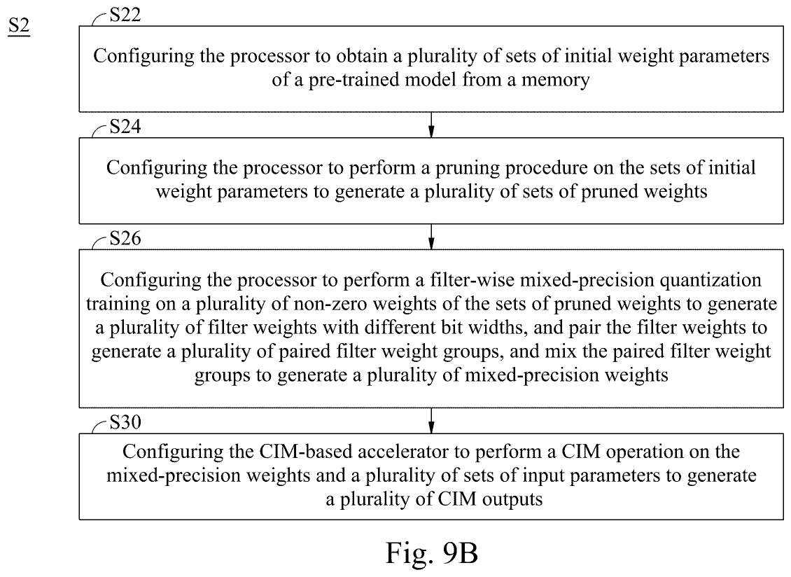

Reference is made to FIGS. 1A, 1B, 9A and 9B. FIG. 9A shows a schematic view of a hardware and software co-design system 100a with a mixed-precision algorithm and a CIM-based accelerator according to a third embodiment of the present disclosure. FIG. 9B shows a flow chart of a hardware and software co-design method S2 with a mixed-precision algorithm and a CIM-based accelerator according to a fourth embodiment of the present disclosure. The hardware and software co-design system 100a with the mixed-precision algorithm and the CIM-based accelerator is configured to perform the hardware and software co-design method S2 with the mixed-precision algorithm and the CIM-based accelerator, and includes a memory 110a, a processor 120a and the CIM-based accelerator 130a. The memory 110a stores a plurality of sets of initial weight parameters of a pre-trained model and a plurality of sets of input parameters. The processor 120a is electrically connected to the memory 110a. The CIM-based accelerator 130a is electrically connected to the memory 110a and the processor 120a. The memory 110a, the processor 120a and the CIM-based accelerator 130a may be configured to implement the hardware and software co-design method S2 with the mixed-precision algorithm and the CIM-based accelerator. The hardware and software co-design method S2 with the mixed-precision algorithm and the CIM-based accelerator includes performing a plurality of steps S22, S24, S26, S30.

The step S22 includes configuring the processor 120a to obtain a plurality of sets of initial weight parameters of a pre-trained model from the memory 110a. The step S24 includes configuring the processor 120a to perform a pruning quantization joint training step, and the pruning quantization joint training step includes performing a pruning procedure on the sets of initial weight parameters to generate a plurality of sets of pruned weights. The step S26 includes configuring the processor 120a to perform a mixed-precision quantization step, and the mixed-precision quantization step includes performing a filter-wise mixed-precision quantization training on a plurality of non-zero weights of the sets of pruned weights to generate a plurality of filter weights with different bit widths, and pairing the filter weights to generate a plurality of paired filter weight groups, and mixing the paired filter weight groups to generate a plurality of mixed-precision weights. The step S30 includes configuring the CIM-based accelerator 130a to perform a CIM operation on the mixed-precision weights and a plurality of sets of input parameters to generate a plurality of CIM outputs. The main difference between FIG. 9A and FIG. 1A is that the processor 120a in FIG. 9A may not perform the model finetuning operation. The main difference between FIG. 9B and FIG. 1B is that the method in FIG. 9B may not perform the step S08 (the model finetuning step). Therefore, the hardware and software co-design system 100a with the mixed-precision algorithm and the CIM-based accelerator and the hardware and software co-design method S2 with the mixed-precision algorithm and the CIM-based accelerator of the present disclosure utilize the CIM adaptive mixed-precision joint pruning quantization (CAMPQ) algorithm to enable full-scale computations for mixed-precision networks and improve CIM utilization and computational speed, thereby solving the problem of conventional fixed-precision calculations for mixed-precision networks with low utilization and reduced computational efficiency.

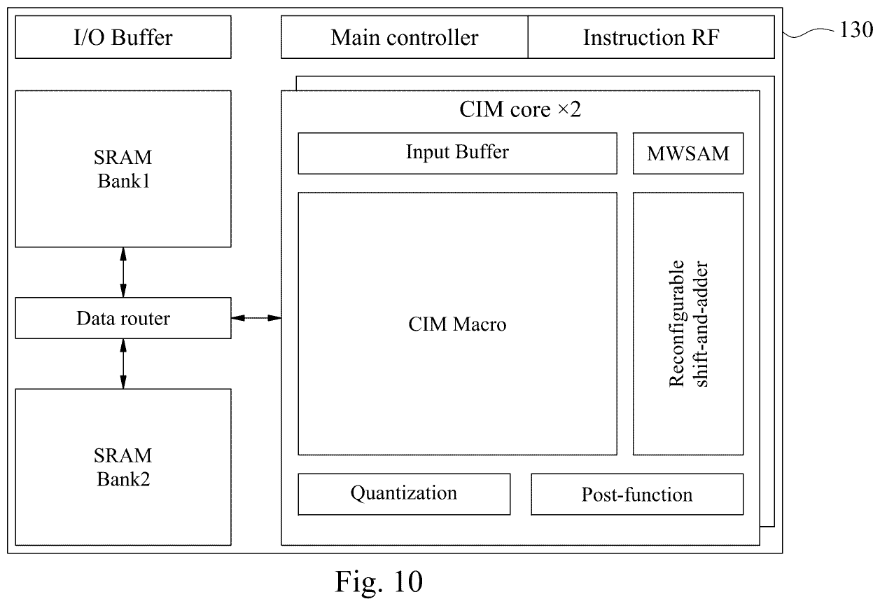

Reference is made to FIGS. 1A, 1B and 10. FIG. 10 shows a schematic view of a CIM-based accelerator 130 of the hardware and software co-design system 100 of FIG. 1A. The CIM-based accelerator 130 includes a main controller with an instruction register file (RF), a data router, two global static random-access memory (SRAM) banks (SRAM Bank1/Bank2), two CIM cores and an input/output (I/O) Buffer. The main controller outputs corresponding control signals to other hardware modules (e.g., the data router, the two global SRAM banks, the two CIM cores and the I/O Buffer) according to the instruction code stored in the instruction register file, which enables the hardware to perform various computations for the supported neural network.

Each of the two CIM cores includes a CIM macro, an input buffer, a mixed-precision weight-sparsity-adaptive module (MWSAM), a reconfigurable shift-and-adder (RSA), a post-function (nonlinear and pooling) module and an on-chip quantization module. Therefore, the present disclosure utilizes the CIM-based accelerator 130 with dynamic hybrid-precision combined with the hardware and software co-design method SO with the mixed-precision algorithm and the CIM-based accelerator to enable full-scale computations for mixed-precision networks while simultaneously supporting sparsity-aware processing, thereby maximizing its advantages, achieving higher CIM macro bit-cell utilization, improved area efficiency, and faster inference speeds.

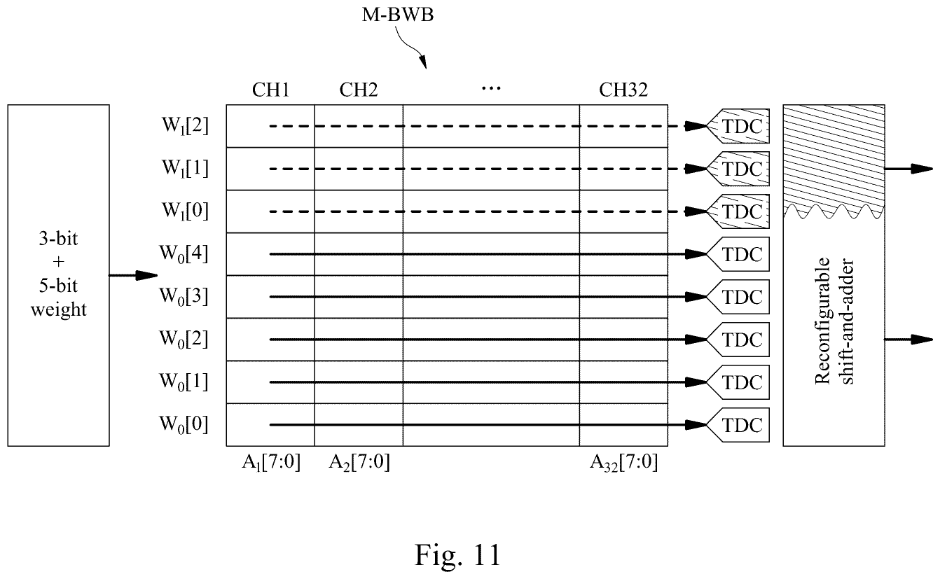

Reference is made to FIGS. 1A, 2, 3, 4, 10 and 11. FIG. 11 shows a schematic view of a multi-bit weight block (M-BWB) of a mixed-precision mapping method of the present disclosure in which two groups of weights (3-bit+5-bit) are mapped to a same partition. In the multi-bit weight block (M-BWB), each of the paired filter weight groups includes a first filter weight W₀ (i.e., W₀[0], W₀[1], W₀[2], W₀[3], W₀[4]) and a second filter weight W₁ (i.e., W₁[0], W₁[1], W₁[2]). The first filter weight W₀ and the second filter weight W₁ are mixed into a same partition to generate the one of the mixed-precision weights (e.g., A₁ [7:0], A₂ [7:0], A₃₂ [7:0]). The first filter weight W₀ and the second filter weight W₁ have a first bit width and a second bit width, respectively. The one of the mixed-precision weights has a third bit width, and the third bit width is equal to the first bit width plus the second bit width. The first bit width, the second bit width and the third bit width may be 5-bit, 3-bit and 8-bit, respectively. Each multi-bit weight block (M-BWB) can store two weights. In addition, in the multi-bit weight block (M-BWB) of the CIM-based accelerator 130, the multiply-and-accumulate (MAC) computation is performed on the mixed-precision weights with 8-bit in the 32 digital input channels (CH1, CH2, CH3, . . . , CH32) and the inputs with 8-bit (input feature maps; IFMs) to generate a plurality of calculation results. Next, the calculation results are sent to a plurality of time-domain conversion units (TDCs) to generate a plurality of conversion outputs, and then the conversion outputs are sent to the RSA. Therefore, the present disclosure maps two groups of the mixed-precision weights to the same partition, thus being capable of achieving higher CIM macro bit-cell utilization.

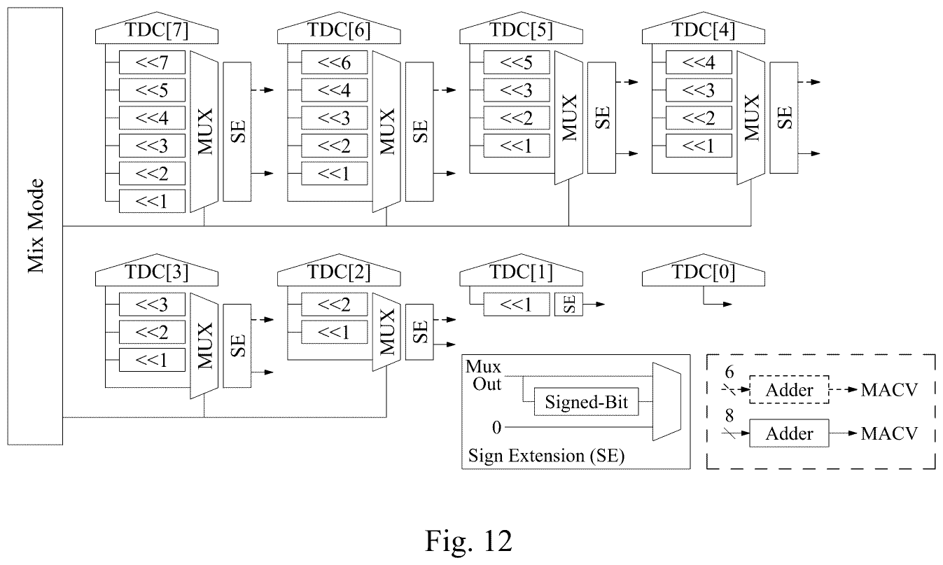

Reference is made to FIGS. 10, 11 and 12. FIG. 12 shows a schematic view of a reconfigurable shift-and-adder (RSA) of the CIM-based accelerator 130 of FIG. 10. The eight time-domain conversion units TDC[7], TDC[6], TDC[5], TDC[4], TDC[3], TDC[2], TDC[1], TDC[0] of FIG. 12 are respectively corresponding to the eight time-domain conversion units TDC from the top to the bottom in FIG. 11. The RSA includes a plurality of shifters (e.g., “«1”, “«2”, “«3”, “«4”, “«5”, “«6” and “«7”), a plurality of multiplexers (MUX), a plurality of sign extension (SE) units and a plurality of adders (Adder). The multiplexers (MUX) are controlled by a mix mode. The RSA may shift this value to the left by n bits according to the mixed-precision mapping method, considering the sign and ultimately add it to the outputs of other bits to obtain the correct MAC value (MACV) for the n-bit weight.

Each of the memories 110, 110a may be a random access memory (RAM) or another type of dynamic storage device that stores information, messages and instructions for execution by the processors 120, 120a. Each of the processors 120, 120a may be a central processing Unit (CPU), a graphics processing unit (GPU), a computer, a mobile device processor, a cloud processing unit or another high-performance computing processor. The structures of the CIM-based accelerators 130, 130a can be the same as each other, but the present disclosure is not limited thereto.

The hardware and software co-design methods SO, S2 with the mixed-precision algorithm and the CIM-based accelerator of the present disclosure are performed by the aforementioned steps. A computer program of the present disclosure stored on a non-transitory tangible computer readable recording medium is used to perform the hardware and software co-design methods SO, S2 described above. The aforementioned embodiments can be provided as a computer program product, which may include a machine-readable medium on which instructions are stored for programming a computer (or other electronic devices) to perform a process based on the embodiments of the present disclosure. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, or another type of media/machine-readable medium suitable for storing electronic instructions. Moreover, the embodiments of the present disclosure also can be downloaded as a computer program product, which may be transferred from a remote computer to a requesting computer by using data signals via a communication link (such as a network connection or the like). Furthermore, the aforementioned embodiments can be implemented by using a non-transitory computer readable recording medium storing instructions which when executed by the processors 120, 120a and the CIM-based accelerators 130, 130a configured to perform the hardware and software co-design methods SO, S2 with the mixed-precision algorithm and the CIM-based accelerator.

According to the aforementioned embodiments and examples, the advantages of the present disclosure are described as follows.
1. The present disclosure utilizes the CIM friendly mapping architecture (CFMA) for mixed-precision computation in CIM, which reduces redundant space for mixed-precision models.
2. The present disclosure utilizes the two-stage joint training framework to be capable of reducing the accuracy loss caused by structured pruning.
3. The present disclosure utilizes the filter-wise mixed-precision quantization (FWMQ) method to be capable of improving accuracy and CIM utilization of the mixed-precision networks.
4. The present disclosure utilizes the CIM-adaptive paired-to-paired bit-width discretization (P2P) method to be capable of pairing and adjusting the bit widths according to the hardware limitation of the CIM, thereby reducing quantization errors and maintaining accuracy while improving CIM computational efficiency.
5. The present disclosure utilizes the CIM adaptive mixed-precision joint pruning quantization (CAMPQ) algorithm to enable full-scale computations for mixed-precision networks and improve CIM utilization and computational speed, thereby solving the problem of conventional fixed-precision calculations for mixed-precision networks with low utilization and reduced computational efficiency.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A hardware and software co-design system with a mixed-precision algorithm and a computing-in-memory (CIM)-based accelerator, comprising:
a memory storing a plurality of sets of initial weight parameters of a pre-trained model and a plurality of sets of input parameters;
a processor electrically connected to the memory and configured to perform operations comprising:
performing an initial weight obtaining operation, wherein the initial weight obtaining operation comprises obtaining the sets of initial weight parameters of the pre-trained model from the memory;
performing a pruning quantization joint training operation, wherein the pruning quantization joint training operation comprises performing a pruning procedure on the sets of initial weight parameters to generate a plurality of sets of pruned weights; and
performing a mixed-precision quantization operation, wherein the mixed-precision quantization operation comprises performing a filter-wise mixed-precision quantization training on a plurality of non-zero weights of the sets of pruned weights to generate a plurality of filter weights with different bit widths, and pairing the filter weights to generate a plurality of paired filter weight groups, and mixing the paired filter weight groups to generate a plurality of mixed-precision weights; and
the CIM-based accelerator electrically connected to the memory and the processor, and receiving the mixed-precision weights and the sets of input parameters, wherein the CIM-based accelerator performs a CIM operation on the mixed-precision weights and the sets of input parameters to generate a plurality of CIM outputs.

2. The hardware and software co-design system with the mixed-precision algorithm and the CIM-based accelerator of claim 1, wherein one of the mixed-precision weights corresponds to one of the paired filter weight groups, and the one of the paired filter weight groups comprises two of the filter weights.

3. The hardware and software co-design system with the mixed-precision algorithm and the CIM-based accelerator of claim 2, wherein each of the paired filter weight groups comprises a first filter weight and a second filter weight, the first filter weight and the second filter weight are mixed into a same partition to generate the one of the mixed-precision weights, the first filter weight and the second filter weight have a first bit width and a second bit width, respectively, the one of the mixed-precision weights has a third bit width, and the third bit width is equal to the first bit width plus the second bit width.

4. The hardware and software co-design system with the mixed-precision algorithm and the CIM-based accelerator of claim 3, wherein the mixed-precision quantization operation further comprises:
in response to determining that the paired filter weight groups are generated, the processor checks whether a sum of the first bit width and the second bit width is greater than a predetermined mixed-precision bit width to generate a first checking result;
in response to determining that the first checking result is yes, the processor checks whether the first bit width and the second bit width are both greater than a predetermined intermediate bit width to generate a second checking result, and adjusts one of the first bit width and the second bit width according to the second checking result; and
in response to determining that the first checking result is no, the processor mixes the first filter weight and the second filter weight into the same partition to generate the one of the mixed-precision weights.

5. The hardware and software co-design system with the mixed-precision algorithm and the CIM-based accelerator of claim 4, wherein the mixed-precision quantization operation further comprises:
in response to determining that the second checking result is yes, the processor calculates a first standard deviation of the first filter weight and a second standard deviation of the second filter weight, and compares the first standard deviation and the second standard deviation to output a smaller one of the first standard deviation and the second standard deviation, if the smaller one is the first standard deviation, the processor adjusts the first bit width, if the smaller one is the second standard deviation, the processor adjusts the second bit width, so that the sum of the first bit width and the second bit width is equal to the predetermined mixed-precision bit width; and
in response to determining that the second checking result is no, the processor calculates the first standard deviation of the first filter weight and the second standard deviation of the second filter weight, and compares the first standard deviation and the second standard deviation to output a larger one of the first standard deviation and the second standard deviation, if the larger one is the first standard deviation, the processor adjusts the first bit width, if the larger one is the second standard deviation, the processor adjusts the second bit width, so that the sum of the first bit width and the second bit width is equal to the predetermined mixed-precision bit width.

6. The hardware and software co-design system with the mixed-precision algorithm and the CIM-based accelerator of claim 1, wherein the filter-wise mixed-precision quantization training is calculated as follows:
$${x}_{q} = Q ( x , [ {n}_{i} , Δ ] ) = clip ( ⌈ \frac{x}{Δ} ⌋ , - {n}_{i} , {n}_{i} - 1 ) \times Δ ;$$
wherein Q (x, [nᵢ, Δ]) represents that an input signal x is quantized into a b-bit output signal x, by parameters [nᵢ, Δ]; nᵢ represents a step number matrix which is a continuous value; Δ represents a step size of quantization function; [x/Δ] represents rounding of x/Δ; and clip
$$( ⌈ \frac{x}{Δ} ⌋ , - {n}_{i} , {n}_{i} - 1 )$$
represents that when input [x/Δ] is smaller than −nᵢ, −nᵢ is output, when the input [x/Δ] is greater than nᵢ−1, nᵢ−1 is output, and when the input [x/Δ] is greater than or equal to −n; and smaller than or equal to nᵢ−1, [x/Δ] is output.

7. The hardware and software co-design system with the mixed-precision algorithm and the CIM-based accelerator of claim 1, wherein the processor is configured to perform the operations further comprising:
performing a model finetuning operation, wherein the model finetuning operation comprises finetuning a mixed-precision quantization pruning model, and the mixed-precision quantization pruning model is formed by performing the pruning quantization joint training operation and the mixed-precision quantization operation.

8. A hardware and software co-design method with a mixed-precision algorithm and a computing-in-memory (CIM)-based accelerator, comprising:
configuring a processor to obtain a plurality of sets of initial weight parameters of a pre-trained model from a memory;
configuring the processor to perform a pruning quantization joint training step, wherein the pruning quantization joint training step comprises performing a pruning procedure on the sets of initial weight parameters to generate a plurality of sets of pruned weights;
configuring the processor to perform a mixed-precision quantization step, wherein the mixed-precision quantization step comprises performing a filter-wise mixed-precision quantization training on a plurality of non-zero weights of the sets of pruned weights to generate a plurality of filter weights with different bit widths, and pairing the filter weights to generate a plurality of paired filter weight groups, and mixing the paired filter weight groups to generate a plurality of mixed-precision weights; and
configuring the CIM-based accelerator to perform a CIM operation on the mixed-precision weights and a plurality of sets of input parameters to generate a plurality of CIM outputs.

9. The hardware and software co-design method with the mixed-precision algorithm and the CIM-based accelerator of claim 8, wherein one of the mixed-precision weights corresponds to one of the paired filter weight groups, and the one of the paired filter weight groups comprises two of the filter weights.

10. The hardware and software co-design method with the mixed-precision algorithm and the CIM-based accelerator of claim 9, wherein each of the paired filter weight groups comprises a first filter weight and a second filter weight, the first filter weight and the second filter weight are mixed into a same partition to generate the one of the mixed-precision weights, the first filter weight and the second filter weight have a first bit width and a second bit width, respectively, the one of the mixed-precision weights has a third bit width, and the third bit width is equal to the first bit width plus the second bit width.

11. The hardware and software co-design method with the mixed-precision algorithm and the CIM-based accelerator of claim 10, further comprising:
in response to determining that the paired filter weight groups are generated, configuring the processor to check whether a sum of the first bit width and the second bit width is greater than a predetermined mixed-precision bit width to generate a first checking result;
in response to determining that the first checking result is yes, configuring the processor to check whether the first bit width and the second bit width are both greater than a predetermined intermediate bit width to generate a second checking result, and adjust one of the first bit width and the second bit width according to the second checking result; and
in response to determining that the first checking result is no, configuring the processor to mix the first filter weight and the second filter weight into the same partition to generate the one of the mixed-precision weights.

12. The hardware and software co-design method with the mixed-precision algorithm and the CIM-based accelerator of claim 11, further comprising:
in response to determining that the second checking result is yes,
configuring the processor to calculate a first standard deviation of the first filter weight and a second standard deviation of the second filter weight, and compare the first standard deviation and the second standard deviation to output a smaller one of the first standard deviation and the second standard deviation, wherein if the smaller one is the first standard deviation, the processor adjusts the first bit width, if the smaller one is the second standard deviation, the processor adjusts the second bit width, so that the sum of the first bit width and the second bit width is equal to the predetermined mixed-precision bit width; and
in response to determining that the second checking result is no, configuring the processor to calculate the first standard deviation of the first filter weight and the second standard deviation of the second filter weight, and compare the first standard deviation and the second standard deviation to output a larger one of the first standard deviation and the second standard deviation, wherein if the larger one is the first standard deviation, the processor adjusts the first bit width, if the larger one is the second standard deviation, the processor adjusts the second bit width, so that the sum of the first bit width and the second bit width is equal to the predetermined mixed-precision bit width.

13. The hardware and software co-design method with the mixed-precision algorithm and the CIM-based accelerator of claim 8, wherein the filter-wise mixed-precision quantization training is calculated as follows:
$${x}_{q} = Q ( x , [ {n}_{i} , Δ ] ) = clip ( ⌈ \frac{x}{Δ} ⌋ , - {n}_{i} , {n}_{i} - 1 ) \times Δ ;$$
wherein Q (x, [nᵢ, Δ]) represents that an input signal x is quantized into a b-bit output signal x_{q} by parameters [nᵢ, Δ]; nᵢ represents a step number matrix which is a continuous value; Δ represents a step size of quantization function; [x/Δ] represents rounding of x/Δ; and clip
$$( ⌈ \frac{x}{Δ} ⌋ , - {n}_{i} , {n}_{i} - 1 )$$
represents that when input [x/Δ] is smaller than −nᵢ, −nᵢ is output, when the input [x/Δ] is greater than nᵢ−1, nᵢ−1 is output, and when the input [x/Δ] is greater than or equal to −n; and smaller than or equal to nᵢ−1, [x/Δ] is output.

14. The hardware and software co-design method with the mixed-precision algorithm and the CIM-based accelerator of claim 8, further comprising:
configuring the processor to finetune a mixed-precision quantization pruning model, wherein the mixed-precision quantization pruning model is formed by performing the pruning quantization joint training step and the mixed-precision quantization step.

15. A non-transitory computer readable recording medium storing instructions which when executed by a processor and a computing-in-memory (CIM)-based accelerator configured to perform a hardware and software co-design method with a mixed-precision algorithm and the CIM-based accelerator, the hardware and software co-design method with the mixed-precision algorithm and the CIM-based accelerator comprising:
configuring the processor to obtain a plurality of sets of initial weight parameters of a pre-trained model from a memory;
configuring the processor to perform a pruning procedure on the sets of initial weight parameters to generate a plurality of sets of pruned weights;
configuring the processor to perform a filter-wise mixed-precision quantization training on a plurality of non-zero weights of the sets of pruned weights to generate a plurality of filter weights with different bit widths, and pair the filter weights to generate a plurality of paired filter weight groups, and mix the paired filter weight groups to generate a plurality of mixed-precision weights; and
configuring the CIM-based accelerator to perform a CIM operation on the mixed-precision weights and a plurality of sets of input parameters to generate a plurality of CIM outputs.

16. The non-transitory computer readable recording medium of claim 15, wherein one of the mixed-precision weights corresponds to one of the paired filter weight groups, and the one of the paired filter weight groups comprises two of the filter weights.

17. The non-transitory computer readable recording medium of claim 16, wherein each of the paired filter weight groups comprises a first filter weight and a second filter weight, the first filter weight and the second filter weight are mixed into a same partition to generate the one of the mixed-precision weights, the first filter weight and the second filter weight have a first bit width and a second bit width, respectively, the one of the mixed-precision weights has a third bit width, and the third bit width is equal to the first bit width plus the second bit width.

18. The non-transitory computer readable recording medium of claim 17, wherein the hardware and software co-design method with the mixed-precision algorithm and the CIM-based accelerator further comprises:
in response to determining that the paired filter weight groups are generated, configuring the processor to check whether a sum of the first bit width and the second bit width is greater than a predetermined mixed-precision bit width to generate a first checking result;
in response to determining that the first checking result is yes, configuring the processor to check whether the first bit width and the second bit width are both greater than a predetermined intermediate bit width to generate a second checking result, and adjust one of the first bit width and the second bit width according to the second checking result; and
in response to determining that the first checking result is no, configuring the processor to mix the first filter weight and the second filter weight into the same partition to generate the one of the mixed-precision weights.

19. The non-transitory computer readable recording medium of claim 18, wherein the hardware and software co-design method with the mixed-precision algorithm and the CIM-based accelerator further comprises:
in response to determining that the second checking result is yes, configuring the processor to calculate a first standard deviation of the first filter weight and a second standard deviation of the second filter weight, and compare the first standard deviation and the second standard deviation to output a smaller one of the first standard deviation and the second standard deviation, wherein if the smaller one is the first standard deviation, the processor adjusts the first bit width, if the smaller one is the second standard deviation, the processor adjusts the second bit width, so that the sum of the first bit width and the second bit width is equal to the predetermined mixed-precision bit width; and
in response to determining that the second checking result is no, configuring the processor to calculate the first standard deviation of the first filter weight and the second standard deviation of the second filter weight, and compare the first standard deviation and the second standard deviation to output a larger one of the first standard deviation and the second standard deviation, wherein if the larger one is the first standard deviation, the processor adjusts the first bit width, if the larger one is the second standard deviation, the processor adjusts the second bit width, so that the sum of the first bit width and the second bit width is equal to the predetermined mixed-precision bit width.

20. The non-transitory computer readable recording medium of claim 15, wherein the filter-wise mixed-precision quantization training is calculated as follows:
$${x}_{q} = Q ( x , [ {n}_{i} , Δ ] ) = clip ( ⌈ \frac{x}{Δ} ⌋ , - {n}_{i} , {n}_{i} - 1 ) \times Δ ;$$
wherein Q(x, [nᵢ, Δ]) represents that an input signal x is quantized into a b-bit output signal x_{q} by parameters [nᵢ, 4]; nᵢ represents a step number matrix which is a continuous value; Δ represents a step size of quantization function; [x/Δ] represents rounding of x/Δ; and clip
$$( ⌈ \frac{x}{Δ} ⌋ , - {n}_{i} , {n}_{i} - 1 )$$
represents that when input [x/Δ] is smaller than −nᵢ, −nᵢ is output, when the input [x/Δ] is greater than nᵢ−1, nᵢ−1 is output, and when the input [x/Δ] is greater than or equal to −n; and smaller than or equal to nᵢ−1, [x/Δ] is output.
